(19) United States
(12) Patent Application Publication
(10) Pub. No.: US 2004/0193077 A1
(43) Pub. Date: Sep. 30, 2004

(54) Programmable digital-controlling massage machine

(76) Inventors: Yi-Ping Hsu, Kaohsiung (TW); Tai-Chun Wei, Taipei (TW)

Correspondence Address: Rabin & Berdo, P.C., Suite 500, 1101 14th Street, Washington, DC, 20005, US

(21) Appl. No.: 10/401,694

(22) Filed: Mar. 31, 2003

(51) Int. Cl. A61H 7/00

(52) U.S. Cl. 601/49; 601/86; 601/98; 601/103

(57) ABSTRACT

A programmable digital-controlling massage machine includes a table, a carriage assembly, a massage device and a digital-controlling device. The table has a top for a user to lay down on. The carriage assembly is attached to the table and is controlled by the digital-controlling device. The massage device in mounted in the carriage assembly and will be moved to a position corresponding to a channel point of the body. The massage device can use vibrations, infrared heat, compressed air or the combinations to press or rub the channel point. A user can input data about own channel points through a disk, which is made prior to the massage operation.

### BACKGROUND OF THE INVENTION

1. Field of the Invention

The present invention relates to a programmable digital-controlling massage machine, and more particularly to a programmable digital-controlling massage machine that will provide a massage to a given channel point of the body and in accordance with variations of human anatomy.

2. Description of Related Art

Massages are actions of pressing, squeezing or rubbing someone's body in order to reduce pain in their muscles or make them relax. Chinese people believe that there are many imaginary lines, called channels or meridians that connect channel points, also called meridian points of energy in the body, used by doctors who use acupuncture etc to treat patients.

Also, Chinese people believe that it is helpful to maintain good health to massage the channel points of the body, even when a person is not sick. However, people around the world have various shapes or figures, such as tall, short, fat or thin figures. Therefore, positions of the channel points of every human body will not generally be the same.

Massage machines today have various types. Chair type massages are generally used for massage applications. A chair type massage machine generally has massage heads to rub or press the body. Some chair type massage machines also use vibrations to massage the muscles of the body. However, no matter which one is taken, to precisely apply the vibrations or the massage heads at somebody's channel points has not been achieved yet. The conventional massage machines cannot accommodate the figures of all people and are operated with a regular fixed way. When a very tall or a very short person sits on the chair type massage machine, the massage heads of the massaging chair always press and rub at regular fixed positions which might be unsuitable for that particular anatomy.

To overcome the shortcomings, the present invention provides an improved programmable digital-controlling massage machine to mitigate or obviate the aforementioned problems.

### SUMMARY OF THE INVENTION

The main objective of the invention is to provide a programmable digital-controlling massage machine that will accommodate individual channel points to precisely massage the channel points of a human body whatever the particular anatomy of each user.

To achieve the objective, a programmable digital-controlling massage machine of the present invention includes a table, a carriage assembly, a massage device and a digital-controlling device. The table has a top for a user to lay down on. The carriage assembly is attached to the table and is controlled by the digital-controlling device. The massage device is movably mounted in the carriage assembly and will be moved to a position to correspond to a channel point of the body. The massage device can use vibrations, infrared heat, compressed air or combinations thereof to press or rub the channel point. The digital-controlling device is mounted in the table and has a storage medium to store data about the channel points of a particular user. Also, if the storage medium does not have the data of the user, the user can input the data through a disk, which is made prior to the massage operation. Therefore, the massage heads can be maneuvered to precisely the individual requirements of specific users.

Other objectives, advantages and novel features of the invention will become more apparent from the following detailed description when taken in conjunction with the accompanying drawings.

### BRIEF DESCRIPTION OF THE DRAWINGS

FIG. 1 is a front plan view of a programmable digital-controlling massage machine with an actuating device for massaging channel points that allows compressed air to flow out for massage in accordance with the present invention;

FIG. 2 is a top plan view of the programmable digital-controlling massage machine in FIG. 1;

FIG. 3 is a front plan view of an alternative embodiment of a programmable digital-controlling massage machine in accordance with the present invention with massage heads generating vibrations for massage;

FIG. 4 is an operational top plan view of the programmable digital-controlling massage machine in FIG. 1 when a user lies down on a table of the massage machine; and

FIG. 5 is an operational side plan view of the programmable digital-controlling massage machine with respect to FIG. 4.

### DETAILED DESCRIPTION OF PREFERRED EMBODIMENT

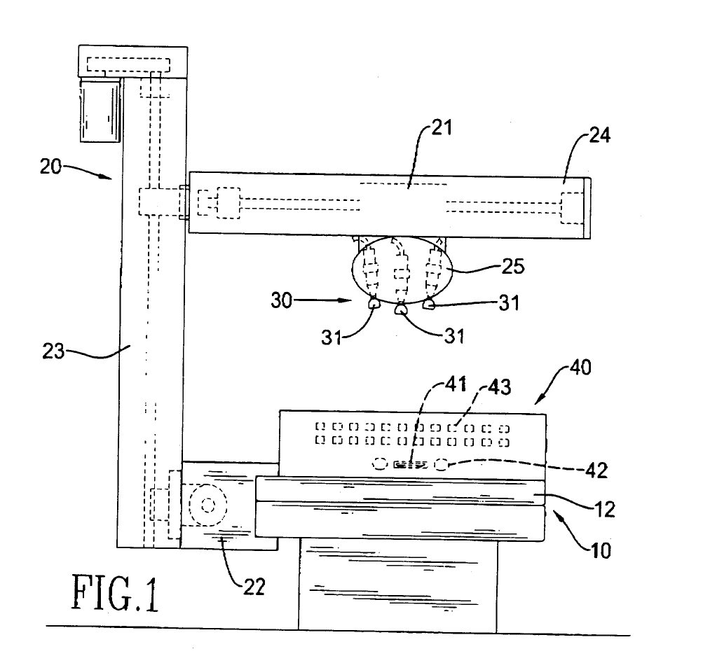

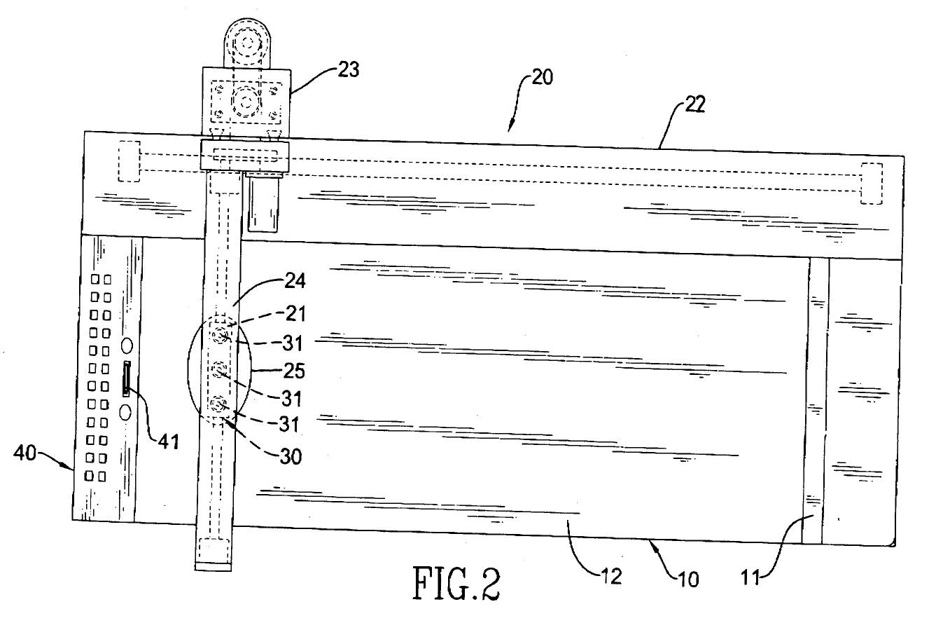

With reference to FIGS. 1 and 2, a programmable digital-controlling massage machine in accordance with the present invention comprises an elongated table (10), a carriage assembly (20), a massage device (30) and a digital-controlling device (40). The carriage assembly (20) is mounted on the table (10) for moving the massage device (30) in three axes over the table (10). The digital-controlling device (40) is mounted on the table (10) and controls movement of the carriage assembly (20) and actuation of the massage device (30).

The table (10) has a flat top (not numbered), a front (not numbered), a rear (not numbered), two opposite sides (not numbered), a datum (not numbered) and a mat (12) that is gas permeable. The mat (12) is attached to the flat top of the table (10) and has a top (not numbered). The mat (12) is made of soft material so a person can lie down on the mat (12) comfortably. The datum can be implemented with a line (not shown) marked on the top of the mat (12) near the rear of the table (10). In the preferred embodiment, the datum is accomplished with an elongated rib (11) transversally mounted on the top of the mat (12) near the rear of the table (10). Optionally, the datum can be formed on the flat top near the rear of the table (10) when the mat (12) of the present invention is not implemented.

The carriage assembly (20) is mounted at one side of the table (10) and comprises a massage device drive (21), an axial drive (22), a column drive (23) and an overhead drive (24). The axial drive (22) is axially mounted at one side from the front to the rear of the table (10) for axial movements of the massage device drive (21). The column drive (23) is vertically attached to the axial drive (22) for vertical movements of the massage device drive (21). The overhead drive (24) is transversally attached to the column drive (23) for transverse movements of the massage device drive (21). All movements of the axial, column and overhead drives (22, 23, 24) are controlled by the digital-controlling device (40). Consequently, the massage device drive (21) will move in three axes.

The massage device drive (21) is movably mounted on the overhead drive (24) with the massage device (30). The massage device drive (21) will also pivot the massage device (30) to an incline to accommodate required angles in massage. Since the carriage assembly (20) moves the massage device drive (21) in three axes, the massage device (30) will be moved and pivoted to a given position and angle to massage any channel point of a body.

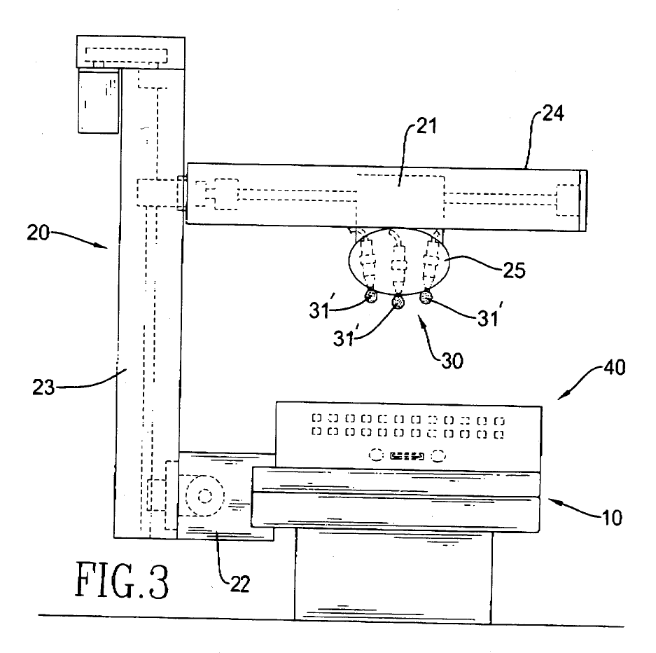

The massage device (30) is mounted in the massage device drive (21) and has a soft wrapping member (25) and an actuating device (not numbered) for massaging the channel points of a body. The actuating device can use vibrations, infrared heat, compressed air with a given frequency or combinations of the above for massage purposes. The actuating device is controlled by the digital-controlling device (40) and can be implemented with nozzles (31) that will allow the compressed air to flow out with a regular frequency. With further reference to FIG. 3, the actuating device also can be implemented with massage heads (31′) that will generate vibrations. In a preferred embodiment, the soft wrapping member (25) can be wrapped around the actuating device to entirely cover the actuating device for protection from dust or contaminants.

With reference to FIGS. 1 and 2, the digital-controlling device (40) is mounted in the front of the table (10) and comprises a controlling circuit board (not shown), a storage medium (not shown), a housing (not numbered), an access medium (41), a switch (42) and functional keys (43). The housing is mounted at the front of the table (10) and has an access board (not numbered) faces toward the rear of the table (10). The controlling circuit board is mounted in the housing and is electrically connected to the carriage assembly (20) and the actuating device to control each of them acting, respectively. The storage medium is ideally implemented with a hard disk, is mounted in the housing and is electrically connected to the controlling circuit board. The storage medium will store information and data of the channels and channel points of a normal human body. Furthermore, the storage medium will also store data of various patients in reference to the channels and the channel points of the body.

The access medium (41), switch (42) and functional keys (43) are attached to the access board of the housing and are electrically connected to the controlling circuit board. The access medium (41) can be implemented with a floppy disk, a compact disk read only machine (CD-ROM) or the like that will allow the user to access the information about the channels and channel points of the user's body from a floppy or a compact disk. The user uses a disk to store data about the channels and channel points of the user. When the user uses the programmable digital-controlling massage machine, the data about the channels and channel points of the user will be inputted into the storage medium through the access medium (41).

The individual data about the channels and the channel points of the user will be developed by using a visual scanning system that will transform the physical data of the user into digital data. The individual data will be stored in a portable, small disk so the user can take it away if necessary. Therefore, the user will enjoy the massage machines in any place where there is a programmable digital-controlling massage machine in accordance with the present invention.

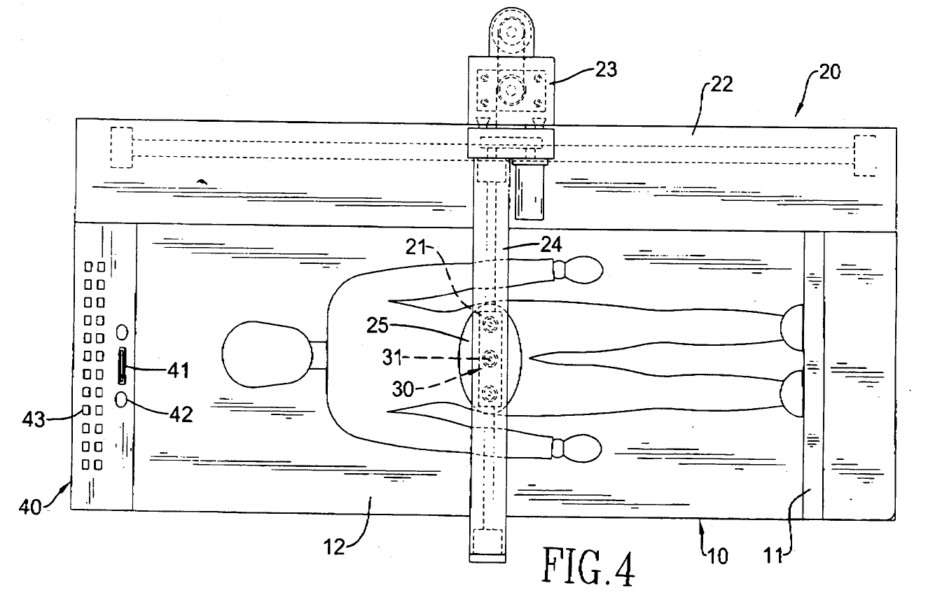

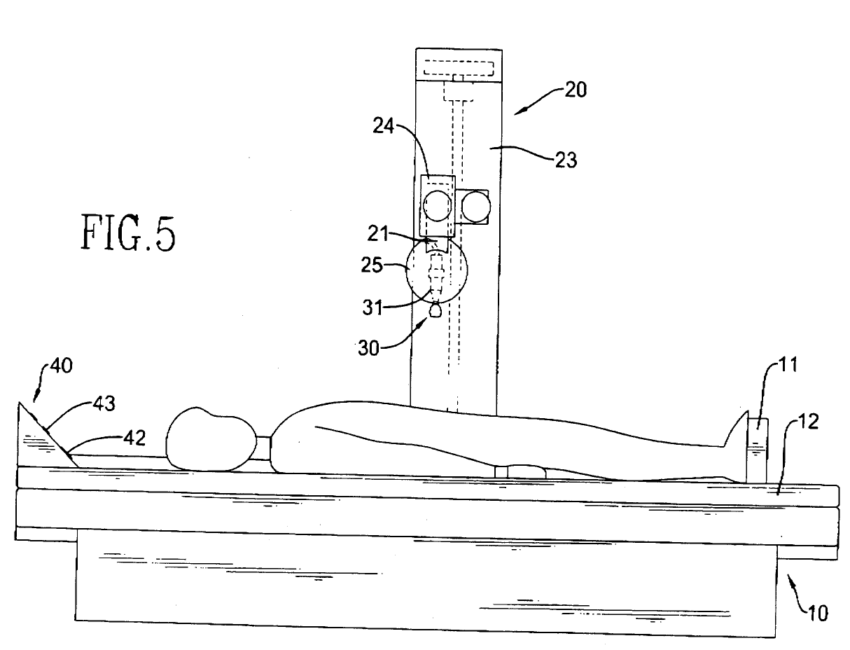

With reference to FIGS. 4 and 5, when a user lies down on the mat (12) over the table (10), the user's feet abut the datum, the elongated rib (11), such that the carriage assembly (20) will be moved precisely. The user can directly operate the programmable digital-controlling massage machine through the switch (42) and the functional keys (43). Furthermore, the operation of the massage machine can also be implemented with remote control.

When the massage machine is started, the carriage assembly (20) will move the massage device (30) to a given position in accordance with the channels and the channel points data of the user. The nozzles (31) of the massage device (30) can use the compressed air with a given blowing frequency to stimulate the channel points of the body. However, if there is no data about the channel points of the user's body being inputted, the massage machine will automatically operate with respect to the channel points data of a normal human body that is stored in the storage medium.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A programmable digital-controlling massage machine comprising:
a table having a flat top, a front, a rear and two opposite sides;
a datum formed on the flat top near the rear of the table;
a carriage assembly mounted at one side of the table and having a massage device drive movably mounted in the carriage assembly for three axes motion;
a massage device rotatably mounted in the massage device drive of the carriage assembly for rotation of the massage device and having an actuating device for massaging channel points of a body; and
a digital-controlling device mounted in the front of the table and comprising
a housing mounted at the front of the table and having an access board;
a controlling circuit board mounted in the housing and electrically connected to the carriage assembly and the actuating device to respectively control each of the carriage assembly and the actuating device;
a storage medium mounted in the housing and electrically connected to the controlling circuit board;
an access medium attached to the access board of the housing and electrically connected to the controlling circuit board;
a switch attached to the access board of the housing and electrically connected to the controlling circuit board; and
multiple functional keys attached to the access board of the housing and electrically connected to the controlling circuit board.

2. The programmable digital-controlling massage machine as claimed in claim 1, wherein the carriage assembly further comprises:
an axial drive axially mounted at one side from the front to the rear of the table for axial movement of the massage device drive;
a column drive vertically attached to the axial drive for vertical movement of the massage device drive; and
an overhead drive transversally attached to the column drive for transverse movement of the massage device drive;
wherein all of the axial, column and overhead drives are controlled by the digital-controlling device, and the massage device drive is movably mounted in the overhead drive.

3. The programmable digital-controlling massage machine as claimed in claim 1 further comprising a soft mat with a top mounted on the flat top of the table with the datum formed on the top of the mat.

4. The programmable digital-controlling massage machine as claimed in claim 2 further comprising a soft mat with a top mounted on the flat top of the table with the datum formed on the top of the mat.

5. The programmable digital-controlling massage machine as claimed in claim 3 further comprising a soft wrapping member wrapped around the actuating device.

6. The programmable digital-controlling massage machine as claimed in claim 4 further comprising a soft wrapping member wrapped around the actuating device.
